(19) United States
(12) Patent Application Publication
(10) Pub. No.: US 2025/0272876 A1
(43) Pub. Date: Aug. 28, 2025

(54) BIM-BASED CAMERA TRACKING METHOD AND APPARATUS IN INDOOR ENVIRONMENTS

(71) Applicants: Korea University Research and Business Foundation, Seoul (KR); iaan Co., Ltd., Seoul (KR)

(72) Inventors: Jung Hyun HAN, Seoul (KR); Jeong Hyeon AHN, Goyang-si (KR); Jung Ho HA, Uijeongbu-si (KR); Jae Min SON, Daegu (KR)

(73) Assignees: Korea University Research and Business Foundation, Seoul (KR); iaan Co., Ltd., Seoul (KR)

(21) Appl. No.: 19/034,102

(22) Filed: Jan. 22, 2025

(30) Foreign Application Priority Data
Feb. 28, 2024 (KR) 10-2024-0028618

(51) Int. Cl. G06T 7/73; G06T 7/13; G06V 20/20

(52) U.S. Cl. CPC G06T 7/75; G06T 7/13; G06V 20/20; G06T 2207/10024; G06T 2207/10028; G06T 2207/20024; G06T 2207/20061

(57) ABSTRACT

A camera tracking apparatus for supporting segmentation based on a building information modeling (BIM) in an indoor environment receives a red/green/blue (RGB) image and a depth map including a pillar photographed by a red/green/blue-depth (RGB-D) camera, detects an RGB edge and a depth edge of a pillar using the RGB image and the depth map, calculates both end points and removes an outlier from a result of combining the RGB edge and the depth edge and detects a scene edge corresponding to the pillar, searches for a BIM edge corresponding to the scene edge using the scene edge, detects a scene face of a floor and the pillar using a face detection algorithm, searches for a BIM face corresponding to the scene face using a center point of the scene face, and removes an incorrect matching result.

### TECHNICAL FIELD

The present invention relates to a building information modeling (BIM)-based camera tracking method and apparatus in an indoor environment.

### BACKGROUND ART

A key element in augmented reality (AR)-based visual inspection tasks is camera tracking.

When a camera pose related to the position and rotation of a camera is not accurately estimated, building information modeling (BIM) is not correctly overlaid on a work site.

In general, in architecture, engineering & construction (AEC) industries, an indoor environment is vast, which makes camera tracking particularly difficult.

For example, regarding a fab for manufacturing semiconductors, the fab consists of various production lines, and general production lines occupy an area of about 10,000 square meters.

In such a vast environment, unrefined camera tracking methods are likely to accumulate drift over time, which ultimately makes visual inspection impossible.

### RELATED ART DOCUMENTS

### Patent Documents

(Patent Document 1) KR Registered Patent Publication No. 10-2432164

### DISCLOSURE

### Technical Problem

In order to solve the above problems of the related art, the present invention is directed to providing a building information modeling (BIM)-based camera tracking method and apparatus in an indoor environment, which is capable of improving the accuracy and robustness of camera tracking.

### Technical Solution

In order to achieve the above purpose, according to one embodiment of the present invention, there is provided a camera tracking apparatus for supporting segmentation based on building information modeling (BIM) in an indoor environment, the camera tracking apparatus including a processor, and a memory connected to the processor, wherein the memory stores program instructions which are executed by the processor to receive a red/green/blue (RGB) image and a depth map including a pillar photographed by a red/green/blue-depth (RGB-D) camera, detect an RGB edge and a depth edge of a pillar using the RGB image and the depth map, calculate both end points and remove an outlier from a result of combining the RGB edge and the depth edge and detect a scene edge corresponding to the pillar, search for a BIM edge corresponding to the scene edge using the scene edge, detect a scene face of a floor and the pillar using a face detection algorithm, search for a BIM face corresponding to the scene face using a center point of the scene face, and remove an incorrect matching result by minimizing a total error which is defined as a weighted sum of an edge error, a face error, a gravity error, and a camera pose error for scene edge and BIM edge pairs matched to each other and scene face and BIM face pairs matched to each other for camera tracking.

The program commands may generate a normal map on a surface of the pillar using the depth map and detect the depth edge of the pillar by performing an OR operation on a result obtained by applying Laplacian filtering to the depth map and the normal map.

The program commands may detect the RGB edge of the pillar by applying a Canny edge detector to the RGB image.

The program commands may perform an AND operation to combine the RGB edge and the depth edge and calculate both end points of the pillar by applying a probabilistic Hough line transform to a result of the combination.

The scene edge may be detected as a plurality of scene edges, and the program commands may remove an outlier from the plurality of scene edges using a Manhattan world assumption that a line segment and a face detected in the indoor environment are perpendicular or parallel to each other.

The program commands may search for a BIM edge of each of the plurality of scene edges by applying a k-d tree based on a Hough transform of the plurality of scene edges and a depth of a center point of each scene edge.

The edge error may be defined by Equation below:

$${E}_{edge} = {\sum }_{i , j} ( {\vert {1}_{i} \cdot {\dot{p}}_{j , 1} \vert}^{2} + {\vert {1}_{i} \cdot {\dot{p}}_{j , 2} \vert}^{2} ) , \qquad [ Equation ]$$

wherein a straight line equation of an i^{th} BIM edge projected onto an i^{th} edge image is aᵢx+bᵢy+cᵢ=0, a three-dimensional vector lᵢ representing the straight line equation is (aᵢ,bᵢ,cᵢ), and homogeneous coordinates of both end points of a detected j^{th} scene edge are \dot{P}_{j,1} and \dot{P}_{j,2}.

The face error may be defined by Equation below:

$${E}_{face} = {\sum }_{i , j} {\vert ( {c}_{i} - {c}_{j} ) \cdot {n}_{j} \vert}^{2} , \qquad [ Equation ]$$

wherein a center point of an i^{th} BIM face is denoted by cᵢ, and a center point and a normal of a j^{th} scene face are denoted by cⱼ and nⱼ.

The gravity error may be defined by Equation below:

$${E}_{grav} = {\vert 1 - {g}_{world} \cdot {R}_{cam} {g}_{imu} \vert}^{2} , \qquad [ Equation ]$$

wherein g_{world}=0, −1,0)^{T}, a rotation matrix of a camera is denoted by R_{cam} and a gravity direction vector measured by an inertial measurement unit (IMU) sensor is denoted by gᵢₘᵤ.

The pose error may defined by Equation below:

$${E}_{pose} = {‖ ( {r}_{cam} , {t}_{cam} ) - ( {r}_{A} , {t}_{A} ) ‖}_{2}^{2} , \qquad [ Equation ]$$

wherein an estimated camera pose is defined as a 6-dimensional vector (r_{A},t_{A}).

According to another aspect of the present invention, there is provided a camera tracking apparatus for supporting segmentation based on BIM in an indoor environment, the camera tracking apparatus including a processor, and a memory connected to the processor, wherein the memory stores program instructions which are executed by the processor to receive an RGB image and a depth map including a pillar photographed by an RGB-D camera, segment a plurality of scene pillar areas from the RGB image using a deep learning-based segmentation algorithm, match the plurality of scene pillar areas to a plurality of BIM pillar areas based on a center point of each of the plurality of scene pillar areas and a center point of each of the plurality of BIM pillar areas generated through rendering, search for a plurality of scene edges and a BIM edge of each of the plurality of scene edges by applying a k-d tree based on a Hough transform of the scene edge calculated in a local space determined by a bounding box calculated in the scene pillar area and a Hough transform of a BIM edge calculated in a local space determined by a bounding box calculated in the BIM pillar area, detect a scene face including a pillar face and a floor face using a distance between adjacent pixels and a normal difference between the adjacent pixels in the scene pillar area, define three-dimensional coordinates and a normal average of the scene face as a center point and a normal and search for a corresponding BIM face using the k-d tree based on the center point and the normal, calculate an error of all matched edge pairs and face pairs and remove pairs that determined to be incorrectly matched, and calculate a final camera pose using remaining edge pairs and face pairs after the removal.

### Advantageous Effects

According to the present invention, the accuracy and robustness of camera tracking can be improved using geometric features such as edges and faces in a textureless indoor environment, thereby enabling an effective augmented reality (AR)-based visual inspection even in a vast indoor environment.

### DESCRIPTION OF DRAWINGS

FIG. 1 is a diagram illustrating a configuration of a camera tracking apparatus according to an exemplary embodiment of the present invention.

FIG. 2 shows diagrams illustrating an edge detection process according to a first embodiment of the present invention.

FIG. 3 is a diagram for describing a Hough transform according to the first embodiment of the present invention.

FIG. 4 shows diagrams illustrating a camera tracking process according to the first embodiment of the present invention.

FIG. 5 shows diagrams illustrating a matching process using pillar area segmentation and a center point according to a second embodiment of the present invention.

FIG. 6 shows diagrams illustrating a process of detecting a scene edge and removing an outlier according to the second embodiment of the present invention.

FIG. 7 shows diagrams illustrating that a pillar is defined in a local space according to the second embodiment of the present invention.

FIG. 8 shows diagrams illustrating a face matching process according to the second embodiment of the present invention.

FIG. 9 shows diagrams illustrating a process of defining a scene pillar area according to the second embodiment of the present invention.

FIG. 10 shows diagrams illustrating a process of processing a case in which a pillar area is incomplete according to the second embodiment of the present invention.

### MODES OF THE INVENTION

Since the present invention can apply various transformations and have various embodiments, specific embodiments will be illustrated in the accompanying drawings and described in detail in the detailed description. However, it should be understood that this is not intended to limit the present invention to specific embodiments, and includes all transformations, equivalents, and substitutes included in the spirit and scope of the present invention.

Terms used in this specification are merely used to describe specific embodiments and are not intended to limit the present invention. An expression of a singular number includes an expression of the plural number, so long as it is clearly read differently. As used herein, the word “comprise” or “has” is used to specify existence of a feature, a numbers, a process, an operation, a constituent element, a part, or a combination thereof, and it will be understood that existence or additional possibility of one or more other features or numbers, processes, operations, constituent elements, parts, or combinations thereof are not excluded in advance.

In addition, components of the embodiments described with reference to each drawing are not limitedly applied only to the corresponding embodiment and may be implemented to be included in other embodiments within the scope of maintaining the technical spirit of the present invention. In addition, it goes without saying that these components may also be re-implemented as one embodiment in which a plurality of embodiments are integrated, even if a separate description is omitted.

In addition, in the description with reference to the accompanying drawings, regardless of reference numerals, the same components will be given the same or related reference numerals and duplicate description thereof will be omitted. In describing the present invention, when it is determined that the specific description of the known related art unnecessarily obscures the gist of the present invention, the detailed description thereof will be omitted.

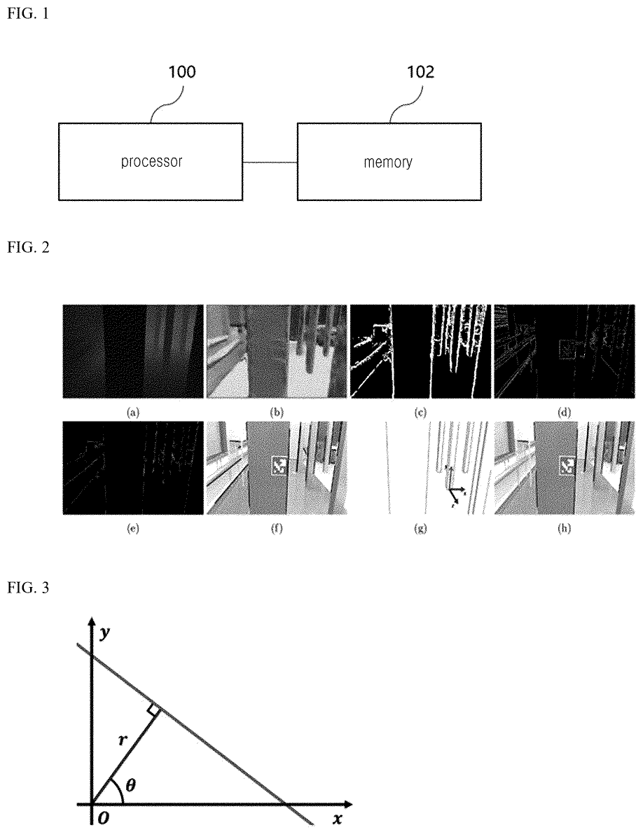

FIG. 1 is a diagram illustrating a configuration of a camera tracking apparatus according to an exemplary embodiment of the present invention.

As shown in FIG. 1, the camera tracking apparatus according to the present embodiment may include a processor 100 and a memory 102.

Here, the processor 100 may include a central processing unit (CPU) capable of executing a computer program, a virtual machine, and the like.

The memory 102 may include a non-volatile storage device such as a fixed hard drive or a removable storage device. The removable storage device may include a compact flash unit, a Universal Serial Bus (USB) memory stick, or the like. The memory 102 may include volatile memories such as various types of random access memories and may be defined as a computer-readable recording medium.

Program commands for detecting scene edges and faces in an indoor environment using an image captured through a red/green/blue-depth (RGB-D) camera and matching the detected scene edges and faces to building information modeling (BIM) edges and faces to perform camera tracking are stored in the memory 102 according to the present embodiment.

Processes described below may be defined as processes in which the processor 100 according to the present embodiment executes program commands.

Considering that it is effective to use geometric features such as pillar edges (hereinafter referred to as “edges”) and faces for simultaneous localization and mapping (SLAM) in a textureless environment, in the present embodiment, based on edges and faces, “scene edges and faces” are detected from an input image and then match to corresponding “BIM edges and faces.”

FIG. 2 shows diagram illustrating an edge detection process according to a first embodiment of the present invention.

FIG. 2 shows a process performed by a camera tracking apparatus according to the first embodiment that receives an RGB image and a depth image (depth map) captured by an RGB-D camera.

By using the input depth map as shown in (a) of FIG. 2, a normal map as shown in (b) of FIG. 2 is generated, and Laplacian filtering is applied to two maps.

Two results to which the Laplacian filtering is applied are combined through an OR operation to detect a depth edge as shown in (c) of FIG. 2, and at the same time, a Canny edge detector is applied to the received RGB image to detect an RGB edge as shown in (d) of FIG. 2.

Next, detected results of the depth edge and the RGB edge are combined using an AND operation as shown in (e) of FIG. 2, and a probabilistic Hough line transform is used to calculate both endpoints of an edge as shown in (f) of FIG. 2.

By using a Manhattan world assumption which is an assumption that a line segment and a face detected in an indoor environment are perpendicular or parallel to each other, an outlier is removed from a detected edge as shown in (g) of FIG. 2, and a scene edge of a pillar is finally detected as shown in (h) of FIG. 2.

As described above, corresponding BIM edges are found using a k-d tree based on a Hough transform (r, θ) of a plurality of detected scene edges and a center point depth.

FIG. 3 is a diagram for describing a Hough transform according to the first embodiment of the present invention.

Scene faces of a floor and a pillar are detected using a well-known face detection technology such as ARKit, and an outlier is removed using a Manhattan world assumption.

A corresponding BIM face is found using a k-d tree based on a three-dimensional (3D) center point of each detected scene face.

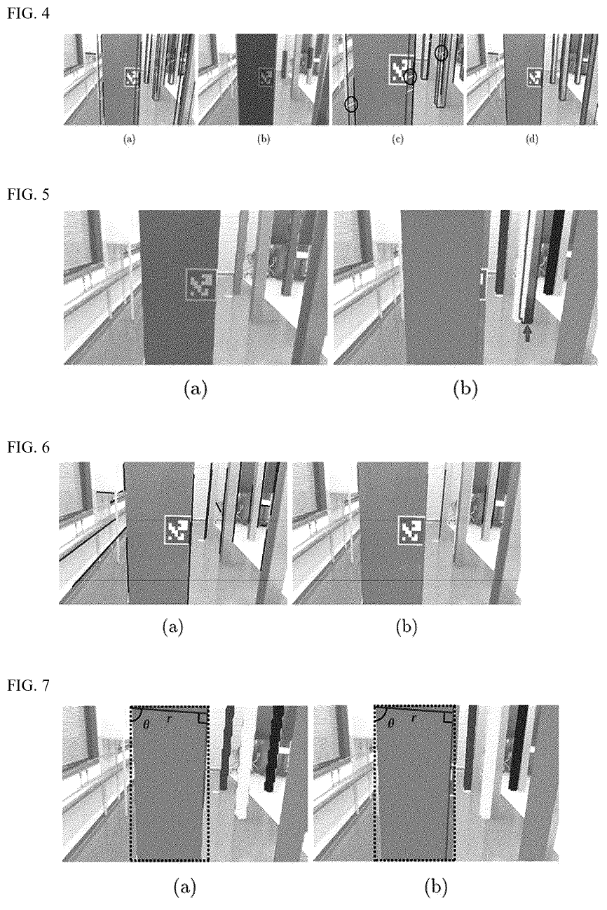

FIG. 4 shows diagrams illustrating a camera tracking process according to the first embodiment of the present invention.

As shown in FIG. 4, camera tracking according to the first embodiment is defined as a task for finding an optimal rigid body motion in which a scene edge pair and a BIM edge pair match to a scene face pair and a BIM face pair matched to each other in FIGS. 2 and 3.

(a) of FIG. 4 illustrates that a scene edge (blue) matches a BIM edge (red). (b) of FIG. 4 illustrates a face detected through ARKit, (c) of FIG. 4 illustrates a case in which three edge pairs indicated by black circles do not satisfy the so-called Manhattan axis constraint, and (d) of FIG. 4 illustrates a state in which a BIM pillar matches to a scene pillar through optimization.

Four errors of an edge, a face, gravity, and a pose are defined for optimization, and the total error is calculated as the weighted sum of the four errors.

When a straight line equation of an i^{th} BIM edge projected onto an i^{th} edge image is aᵢx+bᵢy+cᵢ=0, a 3D vector lᵢ representing the straight line equation is (aᵢ,bᵢ,cᵢ), and homogeneous coordinates of both end points of a detected j^{th} scene edge are denoted by \dot{P}_{j,1} and \dot{P}_{j,2}, an edge error is as follows.

$${E}_{edge} = {\sum }_{i , j} ( {\vert {1}_{i} \cdot {\dot{p}}_{j , 1} \vert}^{2} + {\vert {1}_{i} \cdot {\dot{p}}_{j , 2} \vert}^{2} ) \qquad [ Equation 1 ]$$

When a center point of an i^{th} BIM face is denoted by cᵢ and a center point and a normal of a j^{th} scene face are denoted by cⱼ and cⱼ, a face error is as follows.

$${E}_{face} = {\sum }_{i , j} {\vert ( {c}_{i} - {c}_{j} ) \cdot {n}_{j} \vert}^{2} \qquad [ Equation 2 ]$$

When g_{world}=(0, −1,0)^{T}, a rotation matrix of a camera is denoted by R_{cam} and a gravity direction vector measured by an inertial measurement unit (IMU) sensor is denoted by gᵢₘᵤ, a gravity error is as follows.

$${E}_{grav} = {\vert 1 - {g}_{world} \cdot {R}_{cam} {g}_{imu} \vert}^{2} \qquad [ Equation 3 ]$$

When a camera pose estimated through conventional ARKit is represented by a 6-dimensional vector (r_{A},t_{A}), a pose error is as follows.

$${E}_{pose} = {‖ ( {r}_{cam} , {t}_{cam} ) - ( {r}_{A} , {t}_{A} ) ‖}_{2}^{2} \qquad [ Equation 4 ]$$

Therefore, the total error is as follows, such an optimization problem is solved using a Levenberg-Marquardt method, and an incorrect matching result is removed through a random sample consensus (RANSAC) algorithm.

$$E = {w}_{edge} {E}_{edge} + {w}_{face} {E}_{face} + {w}_{grav} {E}_{grav} + {w}_{pose} {E}_{pose} \qquad [ Equation 5 ]$$

In order to improve the accuracy and robustness of camera tracking, in another embodiment of the present invention (a second embodiment), a pillar segmentation network is used.

As shown in (a) of FIG. 5, a scene pillar area is segmented from an input RGB image using a deep learning-based segmentation algorithm (for example, YOLACT++[Bolya, D., Zhou, C., Xiao, F., Lee, Y. J.: Yolact++: Better real-time instance segmentation. IEEE Transactions on Pattern Analysis and Machine Intelligence (2020)]).

A center point is calculated to find a BIM pillar corresponding to a scene pillar. Pixels within a scene pillar area in a depth map are backprojected into a 3D space, and an average thereof is calculated to define the center point.

Through rendering, a center point of a BIM pillar is calculated in the same manner as in a scene pillar.

A scene pillar and a BIM pillar with close center points match to each other.

Since pillars are spaced apart from each other by several meters or tens of meters in a 3D space as shown in (b) of FIG. 5, a matching process based on such center points is effectively performed.

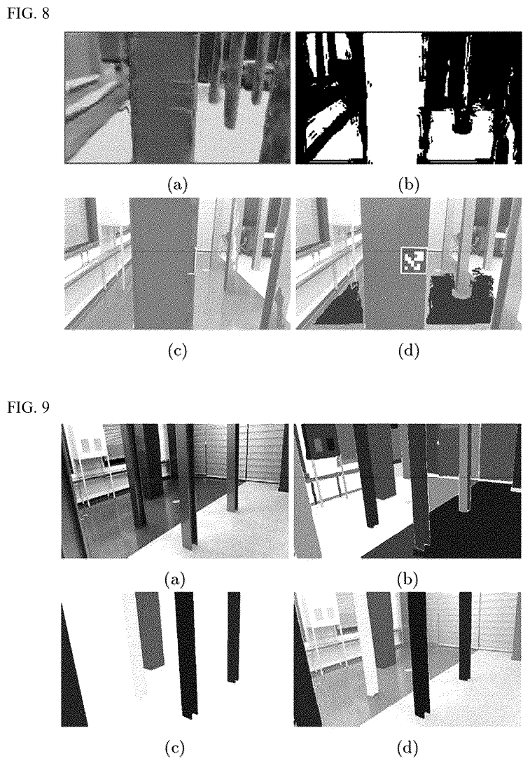

In the second embodiment of the present invention, by applying a k-d tree based on a Hough transform of a scene edge calculated in a local space determined by a bounding box calculated in a scene pillar area and a Hough transform of a BIM edge calculated in a local space determined by a bounding box calculated in a BIM pillar area, a plurality of scene edges and an BIM edge of the plurality of scene edges are searched for to detect scene edges as shown in (a) of FIG. 6 and remove outliers, which do not belong to the scene edges, from pillar segmentation results as shown in (b) of FIG. 6.

In the first embodiment, a Hough transform (r, θ) of each detected scene edge may be defined in an image space, but in the second embodiment, an edge may belong to a specific pillar area, and thus (r, θ) may be defined in a local space of a pillar as shown in (a) of FIG. 7.

For this purpose, a bounding box of a pillar area is calculated, and an upper left end is defined as the origin of a local space.

As shown in (a) of FIG. 7, each BIM edge is also defined in a local space of a rendered BIM pillar.

Edge matching is performed on each pillar based on a pillar matching result, and a scene edge more accurately matches to a BIM edge as compared to the first embodiment.

In the second embodiment, scene face detection is more accurately performed using a pillar area as compared to a related art (ARKit).

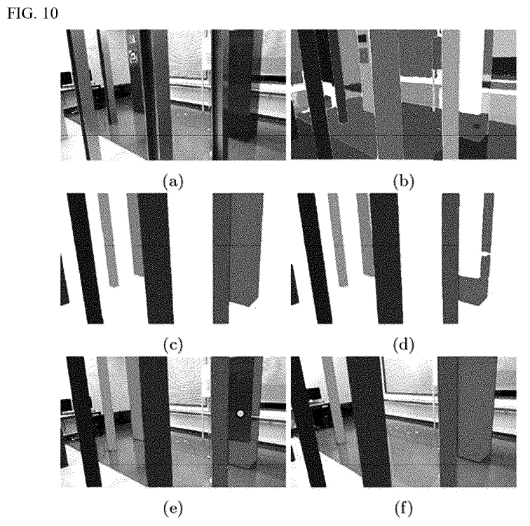

By using a normal map as shown in (a) of FIG. 8, as shown in (b) of FIG. 8, a scene face including a pillar face and a floor face is detected using a distance between adjacent pixels in a scene pillar area and a normal difference between the adjacent pixels to determine whether each pixel belongs to a face.

As shown in (c) of FIG. 8, a part overlapping a pillar area is considered as a pillar face, and as shown in (d) of FIG. 8, a part to which a normal is perpendicular is considered as a floor face.

3D coordinates and a normal average of each part are defined as a center point and a normal of a scene face, and a corresponding BIM face is found using a k-d tree based on the center point and the normal.

Face matching is also performed in units of pillars similar to edge matching, thereby improving accuracy.

In the first embodiment, RANSAC has been used to remove incorrect matching results, but in the second embodiment, since a pillar segmentation network is used, there is almost no incorrect matching result.

Therefore, instead of RANSAC, two-stage optimization is performed.

First, a Levenberg-Marquardt method is used to calculate a camera pose in which all matched scene edge and BIM edge pairs match to scene face and BIM face pairs, and then an error of each pair is calculated through the camera pose to remove pairs that are determined to be incorrectly matched. Afterwards, the remaining pairs are used to calculate a final camera pose.

A dataset for training a pillar segmentation network (YOLACT++) is generated using RGB images captured at various time points in an environment to which the present invention is to be applied. A pillar area is automatically generated and manually post-processed when not completely segmented.

In order to automatically generate a pillar area, a Segment Anything Model (SAM) [Kirillov, A., Mintun, E., Ravi, N., Mao, H., Rolland, C., Gustafson, L., Xiao, T., Whitehead, S., Berg, A. C., Lo, W. Y., Doll'ar, P., Girshick, R.: Segment anything. arXiv:2304.02643 (2023)] is used to segment an input RGB image as shown in (a) and (b) of FIG. 9. Overlapping segmented areas found through a comparison with a BIM area (see (c) of FIG. 9) rendered with a camera pose estimated in a conventional art (ARKit) or the first embodiment of the present invention are collected and defined as scene pillar areas as shown in (d) of FIG. 9.

In order to process cases in which a pillar area automatically generated from an RGB image is incomplete as shown in (d) of FIG. 10, in the present invention, an easy-to-use data processing engine has been developed. The engine includes a function of generating or erasing new areas using a point prompt input of a SAM. An automatically generated pillar mask is displayed on an RGB image through an interface of the engine, and a user corrects an incorrect pillar area as shown in (e) of FIG. 10 to complete a pillar area as shown in (f) of FIG. 10 through a point prompt.

The above-described embodiments of the present invention have been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

1. A camera tracking apparatus for supporting segmentation based on building information modeling (BIM) in an indoor environment, the camera tracking apparatus comprising:
a processor; and
a memory connected to the processor,
wherein the memory stores program instructions which are executed by the processor to receive a red/green/blue (RGB) image and a depth map including a pillar photographed by a red/green/blue-depth (RGB-D) camera,
detect an RGB edge and a depth edge of a pillar using the RGB image and the depth map,
calculate both end points and remove an outlier from a result of combining the RGB edge and the depth edge and detect a scene edge corresponding to the pillar,
search for a BIM edge corresponding to the scene edge using the scene edge,
detect a scene face of a floor and the pillar using a face detection algorithm,
search for a BIM face corresponding to the scene face using a center point of the scene face, and
remove an incorrect matching result by minimizing a total error which is defined as a weighted sum of an edge error, a face error, a gravity error, and a camera pose error for scene edge and BIM edge pairs matched to each other and scene face and BIM face pairs matched to each other for camera tracking.

2. The camera tracking apparatus of claim 1, wherein the program commands are configured to:
generate a normal map on a surface of the pillar using the depth map; and
detect a depth edge of the pillar by performing an OR operation on a result obtained by applying Laplacian filtering to the depth map and the normal map.

3. The camera tracking apparatus of claim 1, wherein the program commands detects the RGB edge of the pillar by applying a Canny edge detector to the RGB image.

4. The camera tracking apparatus of claim 1, wherein the program commands are configured to:
perform an AND operation to combine the RGB edge and the depth edge; and
calculate both end points of the pillar by applying a probabilistic Hough line transform to a result of the combination.

5. The camera tracking apparatus of claim 1, wherein the scene edge is detected as a plurality of scene edges, and
the program commands remove an outlier from the plurality of scene edges using a Manhattan world assumption that a line segment and a face detected in the indoor environment are perpendicular or parallel to each other.

6. The camera tracking apparatus of claim 5, wherein the program commands search for a BIM edge of each of the plurality of scene edges by applying a k-d tree based on a Hough transform of the plurality of scene edges and a depth of a center point of each scene edge.

7. The camera tracking apparatus of claim 1, wherein the edge error is defined by Equation below:
$${E}_{edge} = {\sum }_{i , j} ( {\vert {1}_{i} \cdot {\dot{p}}_{j , 1} \vert}^{2} + {\vert {1}_{i} \cdot {\dot{p}}_{j , 2} \vert}^{2} ) , \qquad [ Equation ]$$
wherein a straight line equation of an i^{th} BIM edge projected onto an i^{th} edge image is aᵢx+bᵢy+cᵢ=0, a three-dimensional vector lᵢ representing the straight line equation is (aᵢ,bᵢ,cᵢ), and homogeneous coordinates of both end points of a detected j^{th} scene edge are \dot{P}_{j,1} and \dot{P}_{j,2}.

8. The camera tracking apparatus of claim 1, wherein the face error is defined by Equation below:
$${E}_{face} = {\sum }_{i , j} {\vert ( {c}_{i} - {c}_{j} ) \cdot {n}_{j} \vert}^{2} , \qquad [ Equation ]$$
wherein a center point of an i^{th} BIM face is denoted by cᵢ, and a center point and a normal of a j^{th} scene face are denoted by cⱼ and nⱼ.

9. The camera tracking apparatus of claim 1, wherein the gravity error is defined by Equation below:
$${E}_{grav} = {\vert 1 - {g}_{world} \cdot {R}_{cam} {g}_{imu} \vert}^{2} , \qquad [ Equation ]$$
wherein g_{world}=(0, −1,0)^{T}, a rotation matrix of a camera is denoted by R_{cam} and a gravity direction vector measured by an inertial measurement unit (IMU) sensor is denoted by gᵢₘᵤ.

10. The camera tracking apparatus of claim 1, wherein the pose error is defined by Equation below:
$${E}_{pose} = {‖ ( {r}_{cam} , {t}_{cam} ) - ( {r}_{A} , {t}_{A} ) ‖}_{2}^{2} , \qquad [ Equation ]$$
wherein an estimated camera pose is defined as a 6-dimensional vector (r_{A},t_{A}).

11. A camera tracking apparatus for supporting segmentation based on building information modeling (BIM) in an indoor environment, the camera tracking apparatus comprising:
a processor; and
a memory connected to the processor,
wherein the memory stores program instructions which are executed by the processor to receive a red/green/blue (RGB) image and a depth map including a pillar photographed by a red/green/blue-depth (RGB-D) camera,
segment a plurality of scene pillar areas from the RGB image using a deep learning-based segmentation algorithm,
match the plurality of scene pillar areas to a plurality of building information modeling (BIM) pillar areas based on a center point of each of the plurality of scene pillar areas and a center point of each of the plurality of BIM pillar areas generated through rendering,
detect an RGB edge and a depth edge of a pillar using the RGB image and the depth map,
search for a plurality of scene edges and a BIM edge of each of the plurality of scene edges by applying a k-d tree based on a Hough transform of the scene edge calculated in a local space determined by a bounding box calculated in the scene pillar area and a Hough transform of a BIM edge calculated in a local space determined by a bounding box calculated in the BIM pillar area,
detect a scene face including a pillar face and a floor face using a distance between adjacent pixels and a normal difference between the adjacent pixels in the scene pillar area,
define three-dimensional coordinates and a normal average of the scene face as a center point and a normal and search for a corresponding BIM face using the k-d tree based on the center point and the normal,
calculate an error of all matched edge pairs and face pairs and remove pairs determined to be incorrectly matched, and
calculate a final camera pose using remaining edge pairs and face pairs after the removal.
